(19) United States
(12) Patent Application Publication
(10) Pub. No.: US 2022/0184602 A1
(43) Pub. Date: Jun. 16, 2022

(54) DEVICE FOR IDENTIFYING AND SEPARATING SPECIMEN AND METHOD FOR IDENTIFYING AND SEPARATING SPECIMEN

(71) Applicant: FURUKAWA ELECTRIC CO., LTD., Tokyo (JP)

(72) Inventors: Toru TAKAHASHI, Tokyo (JP); Ken TSUKII, Tokyo (JP); Kenichi KIMURA, Tokyo (JP); Jie XU, Tokyo (JP)

(73) Assignee: FURUKAWA ELECTRIC CO., LTD., Tokyo (JP)

(21) Appl. No.: 17/425,628

(22) PCT Filed: Jan. 23, 2020
(86) PCT No.: PCT/JP2020/002379

§ 371 Date: Feb. 8, 2022

(30) Foreign Application Priority Data
Jan. 25, 2019 (JP) 2019-011737

(51) Int. Cl. B01L 3/00; G01N 15/14; G01N 1/38

(52) U.S. Cl. CPC B01L 3/502; G01N 15/1434; G01N 1/38; B01L 2200/026; B01L 2200/0636; G01N 2015/149; B01L 2200/18; B01L 2300/0663; B01L 2300/14; B01L 2400/049; B01L 2200/0652

(57) ABSTRACT

An analyte identifying and sorting apparatus for sorting a target analyte based on an identification result of analytes dispersed in a liquid. The apparatus includes an identification unit including an analyte storage section configured to store analytes dispersed in a liquid, a pressure control section configured to feed the liquid to a flow path provided to extend downward from the analyte storage section, a light irradiation section configured to irradiate light to the analytes, an optical information measurement section measuring optical information of the analytes, and a determination section determining whether the analyte is a target analyte or a non-target analyte based on the optical information. Also included is a sorting unit that includes a sorting nozzle connected to the identification unit and sorts a sorted solution containing the target analyte to the vessel, an effluent collection section having a suction nozzle to suck and collect an effluent involving an effluent discharged from a tip of the sorting nozzle, and a collection vessel configured to collect the sorted solution containing the target analyte. A moving unit moves the sorting nozzle and/or the collection vessel, a control unit moves the sorting nozzle and/or the collection vessel based on the optical information, and a stirring unit including a stirring member in an inner space of the analyte storage section.

### TECHNICAL FIELD

The present invention relates to an analyte identifying and sorting apparatus and an analyte identifying and sorting method for identifying analytes dispersed as measurement targets in a liquid and for sorting a target analyte based on a result of identification. In particular, the present invention relates to an analyte identifying and sorting apparatus and an analyte identifying and sorting method that make it possible to stably and continuously sort relatively large analytes.

### BACKGROUND ART

Analyte identifying and sorting apparatuses are widely used to identify and sort minute analytes such as cells for research and inspection in the field of medicine. In recent years, research and inspection institutions have demanded non-destructive identification and sorting of analytes and acceleration of such processes to increase research and inspection efficiency. More recently, a need has also arisen to identify and sort, at high speed, relatively large cells (about 40 to about 100 μm in size), spheroid (three-dimensional cell colony about 50 to about 300 μm in size), and organoid (three-dimensional, in vitro-cultured organ about 50 to about 300 μm in size).

In general, the analyte identifying and sorting apparatus includes a detection section and a sorting section. The detecting section detects optical information which is acquired when light is irradiated to a single analyte. The sorting section collects necessary analytes based on the result of the detection.

In the conventional art, an analyte identifying and sorting apparatus (high-speed, droplet-charging, cell sorter) is proposed. The analyte identifying and sorting apparatus is configured to allow an analyte suspension, which contains analytes (minute analytes) such as cells dispersed in a liquid, to flow through a capillary; to irradiate light from a light source to the flow of the suspension; and to identify analytes by measurement of optical information (scattered light and fluorescent light information) from the analytes in the flow of the suspension (see, for example, Non-Patent Document 1). In this conventional technique, the identification of analytes is followed by ultrasonic vibration of the target analyte-containing suspension at the sorting section to form suspension droplets, which are charged, for example, at several hundred volts. Subsequently, a voltage of several thousand volts is applied from deflection plates to the analyte-containing droplets to allow the droplets to fall on different positions between the positive electrode side and the negative electrode side so that each droplet is sorted to a desired vessel (well).

Such a conventional high-speed, droplet-charging, cell sorter uses ultrasonic wave, high charge, and high water pressure, and such a sorting process may raise concerns that unignorably large physical damage (stress) may be given to living cells, since the target analyte is sorted from the nozzle tip to the desired well of a plate by droplet charging. Moreover, according to such a droplet principle, the size of the droplets is about 40 μm in diameter, and it is impossible to sort the large cells mentioned above.

From such a point of view, an analyte dispensing and identifying apparatus as shown in FIG. 14 is also proposed, which is a non-droplet and cell dispensing type cell sorter (see, for example, Patent Document 1). In this conventional technique, the target analyte-containing liquid, which is not formed into droplets, is dispensed to a desired well of a plate through a nozzle of which the tip is inserted in the well, so that the target analyte is sorted to the well.

Such an analyte dispensing and identifying apparatus 100 includes an analyte storage section 101 that stores analytes dispersed in a liquid; a flow cell 102 having a flow path through which the liquid flows; a sorting nozzle 103; a collection vessel 104; an optical information measurement section 105 that measures optical information of the analytes; and a tube 106 through which the liquid is introduced from the analyte storage section 101 to the flow cell 102.

Unfortunately, in the apparatus shown in FIG. 14, the tube 106, through which analytes dispersed in the liquid flow, has a curved portion 107, which causes, as shown in FIG. 15, a secondary flow 108 toward the outside of the tube 106 (upward in FIG. 15) for the fluid flowing through the curved portion 107 of the flow path.

Moreover, if relatively large analytes as mentioned above are the subject, the analytes will easily settle out in the analyte storage section 101 and become difficult to feed the analytes to the flow cell 102.

In order to solve the problem of the occurrence of the secondary flow 108 due to the curved portion 107 of the tube 106 in the non-droplet and cell dispensing type cell sorter shown in FIG. 14, the inventors have previously proposed an analyte identifying and sorting apparatus (see Patent Document 2) including: an identification unit having: an analyte storage section that stores analytes dispersed in a liquid; a pressure control section for feeding the liquid to a flow path; a light irradiation section for irradiating light to the analytes; an optical information measurement section that measures optical information of the analytes; and a determination section that determine whether the analyte is a target analyte or a non-target analyte based on the optical information; a sorting unit having: a sorting nozzle that has a flow path connected to the flow path of the identification unit and sorts a sorted solution containing a target analyte to a collection vessel; an effluent collection section that sucks and collects an effluent discharged from a tip of the sorting nozzle or an effluent containing a non-target analyte or an analyte determined to be impossible to sort; and a collection vessel for collecting the target analyte-containing sorted solution; a moving unit that moves at least one of the sorting nozzle and the collection vessel; and a control unit that moves the sorting nozzle and/or the collection vessel relatively based on the optical information measured by the optical information measurement section, in which the effluent collection section has a suction nozzle that sucks a non-target analyte-containing effluent discharged from the tip of the sorting nozzle or an effluent containing a non-target analyte or an analyte determined to be impossible to sort.

This analyte identifying and sorting apparatus is configured to determine whether the analyte is a target analyte or a non-target analyte based on the optical information; to move the sorting nozzle and/or the collection vessel relatively based on the optical information such that the tip of the sorting nozzle is inserted into the collection vessel; and to sort, to the collection vessel, a sorted solution containing the target analyte discharged from the tip of the sorting nozzle. In this apparatus, therefore, the target analyte can be collected into a liquid in the collection vessel without coming into contact with the end face of the sorting nozzle, the outer wall or the ambient air, and can be prevented from being contaminated or damaged. Moreover, the non-target analyte-containing effluent discharged from the tip of the sorting nozzle is sucked and collected by the suction nozzle from the sorting nozzle side, which makes it possible to render the distance and duration of the mechanical movement of the effluent collection section shorter than that in the conventional art and to allows a rapid sorting process.

This analyte identifying and sorting apparatus specifically has a flow path configuration as shown in FIG. 16, in which an analyte storage section 11 that stores analytes S and SR dispersed in a liquid A is provided with a flow cell 12 having a flow path 12a through which the liquid A flows. Moreover, an introduction nozzle 15 is provided between the analyte storage section 11 and one end of the flow cell 12. The introduction nozzle 15 has a flow path 15a through which the liquid A is introduced from the analyte storage section 11 to the flow path 12a of the flow cell 12. Furthermore, the other end of the flow cell 12 is provided with a sorting nozzle 14 that has a flow path 14a connected to the flow path 12a and sorts a sorted solution containing the analyte S to a culture plate 55 (collection vessel).
Patent Document 1: Japanese Unexamined Patent Application, Publication No. 2009-2710
Patent Document 1: Japanese Patent No. 5480455
Non-Patent Document 1: Tatsuro Yamashita, Niwa Shinichiro, Cell Technology, Vol. 16, No. 10, pp. 1532-1541, 1997

### DISCLOSURE OF THE INVENTION

### Problems to be Solved by the Invention

As mentioned above, the analyte identifying and sorting apparatus shown in Patent Document 2 has the introduction nozzle that is connected to the analyte storage section and configured to flow the target analyte-containing liquid to the flow cell while narrowing the fluid flow discharged from the analyte storage section to the introduction nozzle. The connected portion between the analyte storage section and the introduction nozzle and the interior of the introduction nozzle may be clogged if local deposition of the analytes or formation of the large analyte aggregates occur in the analyte storage section. As mentioned above, a need exists to also identify and sort the analytes such as relatively large cells, spheroid, organoid at high speed.

Accordingly, it is an object of the present invention to provide an analyte identifying and sorting apparatus and an analyte identifying and sorting method that prevent analytes from being damaged and contaminated during the sorting of target analytes and achieve a stable and rapid sorting process. It is another object of the present invention to provide the analyte identifying and sorting apparatus and the analyte identifying and sorting method that also allow identification and sorting of large analytes such as relatively large cells, spheroid, and organoid, with less damage to the analytes and without flow path clogging. Unit for Solving the Problems

As a result of intensive studies to achieve the objects, the present inventors have completed the present invention based on findings that the objects can be achieved when the analyte identifying and sorting apparatus having a flow path configuration extending downward from the analyte storage section storing analytes dispersed in a liquid is equipped with a stirring unit having a stirring member in the analyte storage section and the stirring unit is operated to keep the dispersion state of the analytes dispersed in the liquid stored in the analyte storage section.

Specifically, the present invention has the following principal configurations.

(1) An analyte identifying and sorting apparatus for identifying analytes dispersed as measurement targets in a liquid and for sorting a target analyte based on a result of identification, the apparatus including: an identification unit including an analyte storage section, a pressure control section, a light irradiation section, an optical information measurement section, and a determination section, the analyte storage section being configured to store analytes dispersed in a liquid, the pressure control section being configured to feed the liquid from an outlet to a flow path, the outlet being provided at a bottom portion of the analyte storage section, the flow path being provided to extend downward from the outlet, the light irradiation section being configured to irradiate light to the analytes, the optical information measurement section measuring optical information of the analytes, and the determination section determining whether each of the analytes is a target analyte or a non-target analyte based on the optical information; a sorting unit including a sorting nozzle, an effluent collection section, and a collection vessel, the sorting nozzle having a flow path connected to the flow path of the identification unit and sorting a sorted solution containing the target analyte to the vessel, the effluent collection section having a suction nozzle to suck and collect an effluent discharged from a tip of the sorting nozzle or an effluent containing a non-target analyte or an analyte determined to be impossible to sort, and the collection vessel being configured to collect the sorted solution containing the target analyte; a moving unit that moves at least one of the sorting nozzle and the collection vessel; a control unit that moves the sorting nozzle and/or the collection vessel relatively based on the optical information measured by the optical information measurement section; and a stirring unit including a stirring member provided in an inner space of the analyte storage section.

(2) The analyte identifying and sorting apparatus according to aspect (1), in which the stirring member is rotated about a rotation axis extending in a vertical direction.

(3) The analyte identifying and sorting apparatus according to aspect (1) or (2), in which the stirring member has a bottom portion with a rotation area that is larger than an area of the outlet of the analyte storage section when the stirring member is rotated.

(4) The analyte identifying and sorting apparatus according to any one of aspects (1) to (3), in which the analyte storage section has a bottom portion inclined toward the outlet.

(5) The analyte identifying and sorting apparatus according to any one of aspects (1) to (4), in which the stirring member is spaced apart from an inner surface of the analyte storage section.

(6) The analyte identifying and sorting apparatus according to any one of aspects (1) to (5), in which the stirring member has at least one stirring blade extending in a horizontal direction from the vertically extending rotation axis of the stirring member.

(7) The analyte identifying and sorting apparatus according to aspect (6), in which the stirring blade has a horizontal width increasing gradually in a direction from a top side of the analyte storage section to a bottom side of the analyte storage section.

(8) The analyte identifying and sorting apparatus according to any one of aspects (1) to (7), further including a flow path that is connected to the flow path of the identification unit and allows an analyte-free liquid to form a sheath flow-forming portion surrounding an analyte-containing liquid output from the analyte storage section, and the analyte identifying and sorting apparatus being configured to allow the analyte-free liquid to flow back from the outlet of the analyte storage section to effect stirring in the analyte storage section by control the pressure control section.

(9) An analyte identifying and sorting method for identifying analytes dispersed as measurement targets in a liquid and for sorting a target analyte based on a result of identification, the method including: storing analytes in an analyte storage section, the analytes being dispersed in a liquid, the analyte storage section having an outlet for the liquid at a bottom portion; feeding the liquid to a flow path, the liquid being stirred by a stirring unit including a stirring member provided in an inner space of the analyte storage section; irradiating light to the analytes; measuring optical information of the analytes; determining whether each of the analytes is a target analyte or a non-target analyte based on the optical information; sucking and collecting an effluent discharged from a tip of a sorting nozzle connected to the flow path or an effluent containing a non-target analyte or an analyte determined to be impossible to sort by a suction nozzle; making a control based on the optical information to move the sorting nozzle and/or a collection vessel relatively such that the tip of the sorting nozzle is inserted into the collection vessel; and sorting a sorted solution containing the target analyte discharged from the tip of the sorting nozzle to the collection vessel.

### Effects of the Invention

According to the present invention, the stirring unit having the stirring member is provided in the analyte storage section to stir the liquid in the analyte storage section and the dispersion state of the analytes dispersed in the liquid stored in the analyte storage section is kept, which make it possible to prevent the analytes from settling out directly on the outlet of the analyte storage section and clogging the outlet when the analytes are introduced through the outlet into a flow path provided to determine whether each of the analytes is a target analyte or a non-target analyte, and which also allows the analytes near the outlet of the analyte storage section to easily flow into the outlet. In such a state, the analytes are identified and sorted in a non-droplet process with shortened distance and duration of mechanical movement of the effluent collection section, which makes it possible to stably and efficiently identify and sort the analytes with less damage to the analytes. Moreover, even relatively large analytes can be well identified and sorted without causing clogging. From the outlet of the analyte storage section, an analyte-free liquid can also be allowed to flow back for stirring in the analyte storage section separately from the stirring by the stirring unit during the identification and sorting of the analytes. Such back flow makes it possible to prevent the analytes from settling out and staying close to the outlet and to provide a better operation for the analyte identification and sorting.

### BRIEF DESCRIPTION OF THE DRAWINGS

FIG. 1 is a perspective view schematically showing the configuration of the whole of an analyte identifying and sorting apparatus according to an embodiment of the present invention.

FIG. 2 is a partial cross-sectional view schematically showing an area from an analyte storage section to a tip of a sorting nozzle in the analyte identifying and sorting apparatus shown in FIG. 1.

FIGS. 3(a) to 3(g) are views schematically showing examples of the shape of a stirring member used in the analyte identifying and sorting apparatus according to an embodiment of the present invention.

FIGS. 4(a) to 4(d) are cross-sectional views schematically showing examples of the shape of the stirring blade or blades used in the analyte identifying and sorting apparatus according to an embodiment of the present invention.

FIG. 5 is a cross-sectional view schematically showing an example of the shape of a stirring blade used in the analyte identifying and sorting apparatus according to an embodiment of the present invention.

FIG. 6 is a partial cross-sectional view schematically showing the configuration of an analyte storage section in an analyte identifying and sorting apparatus according to another embodiment of the present invention.

FIG. 7 is a partial cross-sectional view schematically showing the configuration of an analyte storage section in an analyte identifying and sorting apparatus according to another embodiment of the present invention.

FIGS. 8(a) to 8(c) are cross-sectional views showing the configuration of a bottom portion of an analyte storage section in an analyte identifying and sorting apparatus according to a further embodiment of the present invention.

FIGS. 9(a) to 9(d) are cross-sectional views each schematically showing the positional relationship between the stirring member and the bottom portion of the analyte storage section in an analyte identifying and sorting apparatus according to a further embodiment of the present invention.

FIG. 10 is a block diagram illustrating the function of the analyte identifying and sorting apparatus shown in FIG. 1.

FIGS. 11(a) to 11(d) are views illustrating operation of the sorting unit shown in FIG. 10.

FIGS. 12(a) to 12(d) are enlarged views of an area at and near a sorting nozzle during the operation shown in FIGS. 11(a) to 11(d).

FIG. 13 is a flowchart of an analyte identifying and sorting process performed in the analyte identifying and sorting apparatus shown in FIG. 1.

FIG. 14 is a perspective view schematically showing the configuration of the whole of an example of a conventional analyte identifying and sorting apparatus.

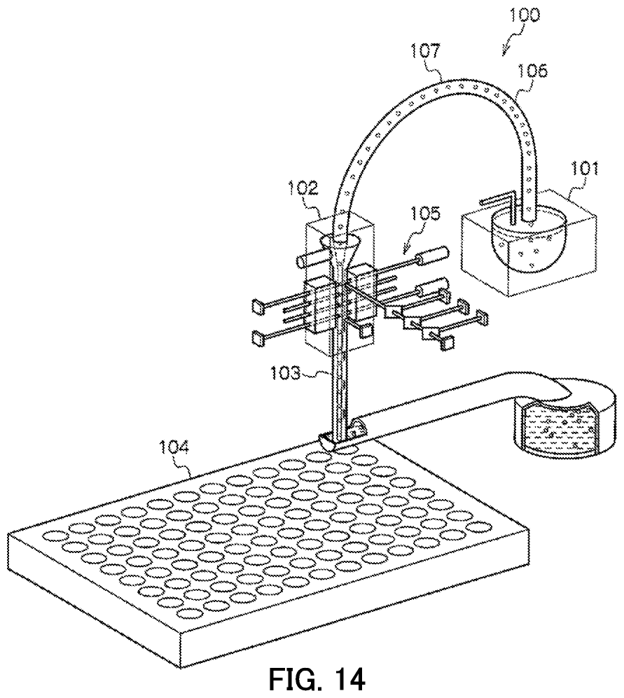

FIG. 15 is a diagram illustrating a state of a fluid flowing in the flow path of a curved portion of the analyte identifying and sorting apparatus shown in FIG. 14.

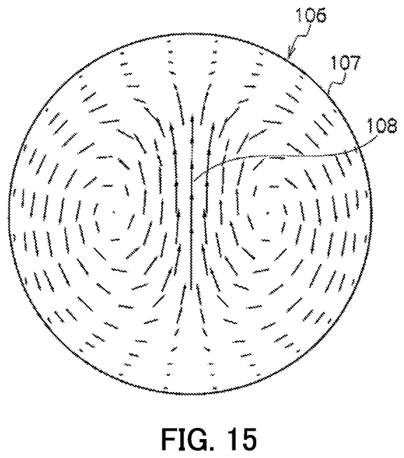

FIG. 16 is a partial cross-sectional view schematically showing an area from an analyte storage section to a tip of a sorting nozzle in another example of a conventional analyte identifying and sorting apparatus.

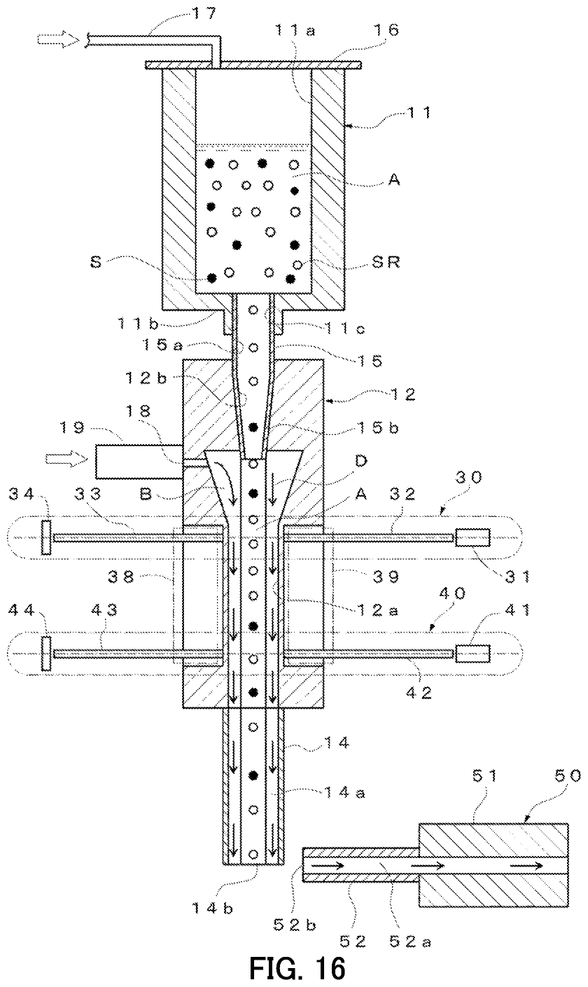

### PREFERRED MODE FOR CARRYING OUT THE INVENTION

Hereinafter, embodiments of the present invention will be described in detail with reference to the drawings.

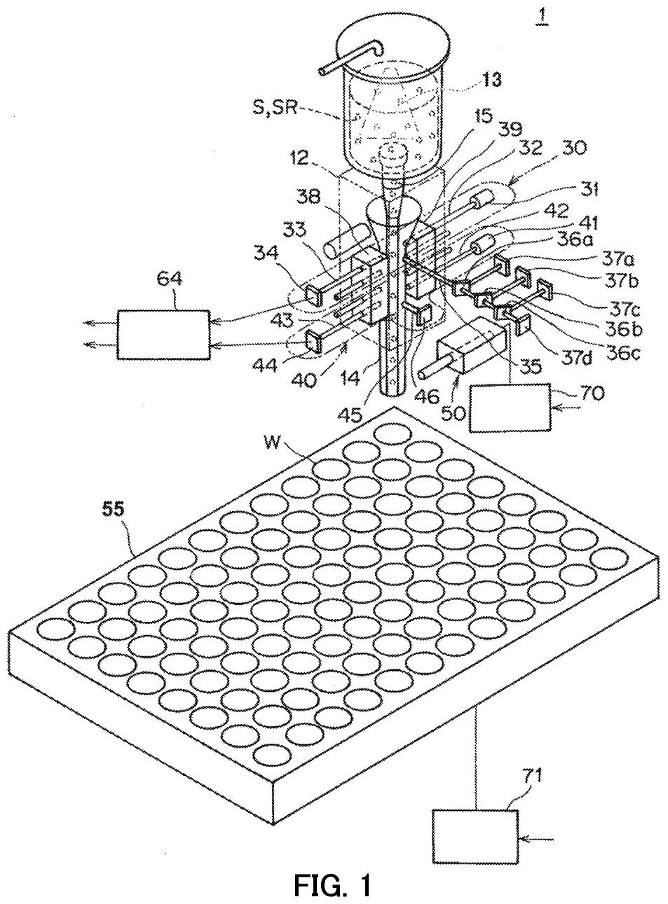

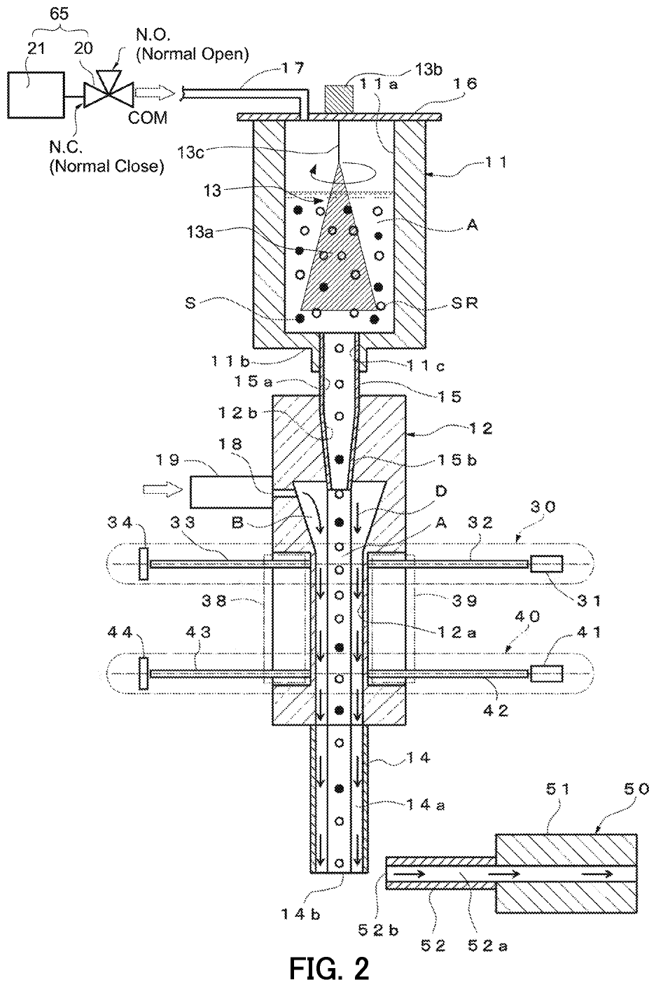

FIG. 1 is a perspective view schematically showing the configuration of the whole of an analyte identifying and sorting apparatus according to an embodiment of the present invention, and FIG. 2 is a partial cross-sectional view schematically showing the configuration of the analyte identifying and sorting apparatus. The analyte identifying and sorting apparatus according to this embodiment is configured to irradiate excitation light to analytes to be measured, such as cells, dispersed as measurement targets in a liquid flowing through a flow path; to measure optical information of the analytes; to determine whether or not it is necessary to sort each of the analytes based on the optical information; and to sort, into a collection vessel, a target analyte which has been determined to be sorted as a result of the determination. In FIGS. 1 and 2, the analytes S each indicated by an open circle are target analytes to be sorted, and the analytes SR each indicated by a solid circle are non-target analytes to be discarded.

As shown in FIGS. 1 and 2, an analyte identifying and sorting apparatus 1 includes an analyte storage section 11 that is configured to store analytes S and SR dispersed in a liquid A; a flow cell 12 having a flow path 12a through which the liquid A flows; and a sorting nozzle 14 that has a flow path 14a connected to the flow path 12a of the flow cell 12 and sorts a sorted solution containing the analyte S to a culture plate 55 (collection vessel). In the analyte identifying and sorting apparatus 1, the analyte storage section 11 is equipped with a stirring unit 13 having a stirring member 13a provided in the inner space of the analyte storage section 11. The agitation unit 13 includes the stirring member 13a; and a stirring driver 13b that drives and rotates the stirring member 13a. The liquid A is a sample suspension containing the analytes S and the analytes SR dispersed in a solution. In this apparatus, the stirring unit 13 described below includes a stirring member 13a having a stirring blade with a substantially triangular cross-section along the vertical direction.

The analyte storage section 11 is a tubular vessel, such as a cylindrical vessel, having an opening 11a in the upper portion, through which the liquid A is introduced; and an outlet 11c at a bottom portion 11b in the lower portion. The outlet 11c is located at the bottom portion 11b of the analyte storage section 11, in other words, located in the lower portion of the analyte storage section 11. The outlet 11c is connected to a flow path 15a of an introduction nozzle 15 connected to the flow path 12a of the flow cell 12 which is located below the outlet 11c. The area of the outlet of the analyte storage section 11 (also referred to as the flow path cross-sectional area of the outlet 11c) is smaller than the area of the opening 11a. The flow path cross-sectional area of the outlet 11c is the area of the horizontal cross-section of the outlet 11c. The area of the opening 11a is the area of the horizontal cross-section of the opening 11a. The analyte storage section 11 has the function of storing the analytes dispersed in the liquid A. An openable and closable lid 16 is provided on the upper opening 11a of the analyte storage section 11. The lid 16 is provided with a pipe 17. The pipe 17 allows pressurized air at a specific adjusted pressure to be introduced from outside into the analyte storage section 11 and allows air to be evacuated from the analyte storage section 11. The liquid A is fed at a predetermined pressure to the flow path 15a as the pressurized air is introduced through the pipe 17 into the analyte storage section 11. The feeding of the liquid A to the flow path 15a can be stopped by stopping the introduction of the pressurized air through the pipe 17 into the analyte storage section 11, and, as described later, a sheath liquid can be allowed to flow back into the analyte storage section 11 through the outlet 11c when the air is evacuated from the analyte storage section 11 through the pipe 17. During the operation of the analyte identifying and sorting apparatus, the inner space of the analyte storage section 11 is closed to such an extent that the pressure in the analyte storage section 11 can be adjusted in such a way.

The pipe 17 is connected to a pressure control section 65. The pressure control section 65 controls pressure to feed the liquid A from the analyte storage section 11 to flow paths 15a, 12a, and 14a extending downward. The pressure control section 65 includes, for example, a compression machine 21 such as a compressor and an open valve 20 such as a three-way valve. The open valve 20 is provided between the compression machine 21 and the pipe 17. Thus, the pressure in the analyte storage section 11 can be controlled by controlling the compression machine 21 and the open valve 20. For back flow of the sheath liquid, the analyte storage section 11 is opened to the atmosphere. For example, as shown in FIG. 2, the open valve 20 which is the three-way valve functions as follows. The valve connected to the compression machine 21 may always close (N.C.) and may open during the control. The valve connected to the atmosphere may always open (N.O.) and may close during the control. The valve connected to the pipe 17 may always open (COM). However, the control is not limited to the mode shown in FIG. 2 and may be performed in various ways. Moreover, the back flow of the sheath liquid by the three-way valve control is one example of the back flow method, and various other methods may be used, such as controlling the compression machine 21 to reduce the pressure in the analyte storage section 11 or increase the pressure of the sheath liquid for the back flow.

The liquid A may be introduced into the analyte storage section 11, for example, by opening the lid 16 and introducing the liquid A into the analyte storage section 11 through the opening 11a using a pipette or the like, when the analyte storage section 11 is connected to the introduction nozzle 15.

The stirring member 13a of the stirring unit 13 is provided in the inner space of the analyte storage section 11. The stirring member 13a is rotatable about the rotation axis extending in the vertical direction. The stirring member 13a is entirely or partially immersed in the liquid A which is temporarily stored in the interior of the analyte storage section 11 and is discharged from the outlet 11c. As shown in FIG. 2, when the opening 11a is closed with the lid 16, the stirring member 13a is fully housed in the inner space of the analyte storage section 11.

For example, as shown in FIG. 2, a support shaft 13c is provided to suspend the stirring member 13a from above. The support shaft 13c rotatably connects an upper portion of the stirring member 13a to the stirring driver 13b and hermetically passes through the lid 16 when the opening 11a is closed with the lid 16.

The stirring driver 13b is the source of power for the driving force to drive the stirring member 13a. The stirring driver 13b may be provided on the upper surface of the lid 16 as shown in FIG. 2 or may be provided on the wall surface of the analyte storage section 11 or installed in the wall or inner space of the analyte storage section 11.

The rotation of the stirring member 13a can cause the analyte-containing solution to flow uniformly in a certain direction, such that collisions between the analytes can be avoided and damage to the analytes during the stirring can be reduced.

In the embodiment shown in FIGS. 1 and 2, the stirring member 13a described above includes a stirring blade having a substantially triangular cross-section with the base located on the lower side as shown in the drawings. However, the stirring member 13a may have any shape or configuration as long as the stirring member 13a can be provided in the inner space of the analyte storage section 11 and can maintain the dispersity of the analytes in the liquid stored in the analyte storage section 11. As used herein, the stirring member refers to a substantial part that can be moved (e.g., rotated, revolved, swung) to stir the analyte-containing fluid stored in the analyte storage section. Examples of such a substantial part include a blade-shaped stirring member for shear force stirring; a rod-shaped stirring member having a paddle-shaped portion protruding in the radial direction from the rotation axis; a hemispherical or a through-hole-type, blade-free stirring member for centrifugal force stirring; and rotatable members for use with magnetic stirrers, such as cylindrical, tapered, or hub-type rotatable members.

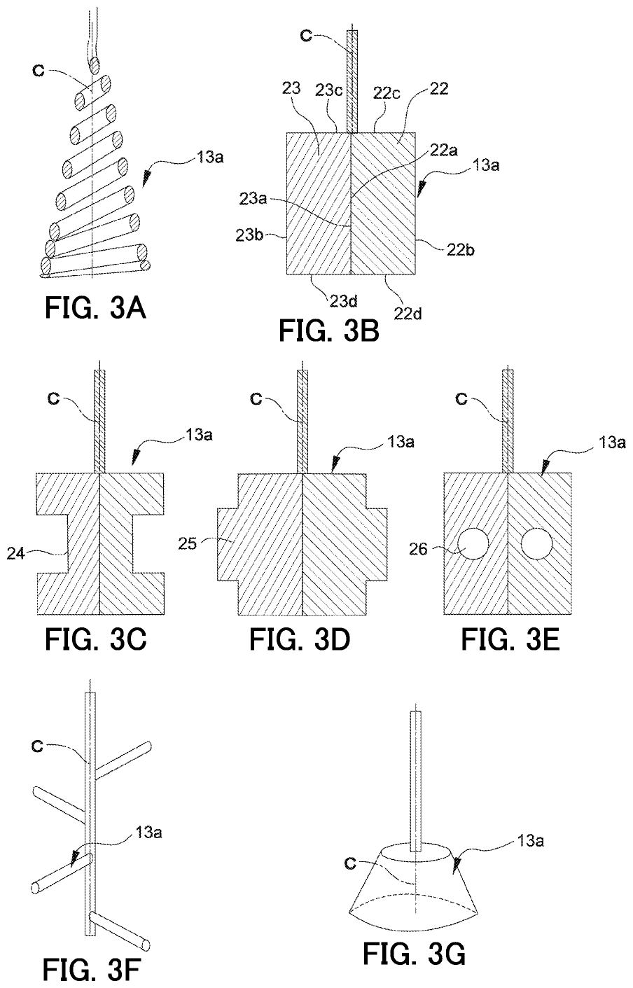

FIGS. 3(a) to 3(g) are views schematically showing examples of the shape of the stirring member used in the analyte identifying and sorting apparatus according to an embodiment of the present invention. The stirring member is not limited to the stirring member having the stirring blade in the embodiment shown in FIGS. 1 and 2, and may be a spiral member having an outer diameter increasing gradually toward the lower side and extending in the vertical direction as shown in the vertical cross-sectional view of FIG. 3(a); a rod-shaped member having branches at its lower end portion as shown in the perspective view of FIG. 3(f); a rod-shaped member having a conical solid portion at one end as shown in the perspective view of FIG. 3(g); or any other rod-shaped member or disk-shaped member. The stirring member may also be a magnetic stirring member without having the support shaft 13c. In this case, the stirring member 13a has a magnet provided inside or on a side, and the stirring driver 13b is a magnetic field generator.

The stirring member may include at least one stirring blade extending in the horizontal direction from the rotation axis of the stirring member for more efficient stirring of the analytes in the liquid. The stirring blade may be in various shapes. Some examples of the blade include, but are not limited to, those shown below.

FIG. 3(b) is an exemplary cross-sectional view of the stirring member 13a, which is parallel to the rotation axis of the stirring member 13a. Hereinafter, the stirring member 13a including two stirring blades, specifically including a first stirring blade 22 and a second stirring blade 23 on both sides about the rotation axis of the stirring member 13a will be described.

The stirring member 13a includes a first rectangular stirring blade 22 and a second rectangular stirring blade 23. The first stirring blade 22 and the second stirring blade 23 are integrated by connecting the first inner side 22a and the second inner side 23a as described later. The first stirring blade 22 and the second stirring blade 23 have the same shape.

The first stirring blade 22 has a first inner side 22a, a first outer side 22b, a first upper side 22c, and a first lower side 22d. The first inner side 22a extends in the vertical direction and is connected to the second stirring blade 23. The first outer side 22b is faced to the first inner side 22a and forms the outer periphery of the first stirring blade 22. The first upper side 22c extends in the horizontal direction to connect the first inner side 22a and the first outer side 22b. The first lower side 22d located below the first upper side 22c is faced to the first upper side 22c and connects the first inner side 22a and the first outer side 22b.

The second stirring blade 23 has a second inner side 23a, a second outer side 23b, a second upper side 23c, and a second lower side 23d. The second inner side 23a extends in the vertical direction and is connected to the first stirring blade 22. The second outer side 23b is faced to the second inner side 23a and forms the outer periphery of the second stirring blade 23. The second upper side 23c extends in the horizontal direction to connect the second inner side 23a and the second outer side 23b. The second lower side 23d located below the second upper side 23c is faced to the second upper side 23c and connects the second inner side 23a and the second outer side 23b.

In the example shown above, the first stirring blade 22 and the second stirring blade 23 have a rectangular cross-section. Alternatively, the first stirring blade 22 and the second stirring blade 23 may each have a cross-section in a shape other than the above. For example, the cross-sectional shape may be a non-rectangular shape such as a circle or a semicircle, or any other polygonal shape such as a triangle or a pentagon. The first stirring blade 22 and the second stirring blade 23 may also be non-identical, in other words different. The stirring member 13a may have only one of the first stirring blade 22 and the second stirring blade 23.

As shown in the cross-sectional view of FIG. 3(c), which is parallel to the rotation axis of the stirring member 13a, at least one of the first stirring blade 22 and the second stirring blade 23 may have a recess 24 extending toward the inside of the stirring member 13a. Alternatively, as shown in the cross-sectional view of FIG. 3(d), which is parallel to the rotation axis of the stirring member 13a, at least one of the first stirring blade 22 and the second stirring blade 23 may have a protrusion 25 protruding toward outside the stirring member 13a. One or two or more recesses 24 or one or two or more protrusions 25 may be provided. Alternatively, the recess 24 or the protrusion 25 may be provided on each upper side 22c or 23c or each lower side 22d or 23d instead of on each outer side 22b or 23b.

Moreover, as shown in the cross-sectional view of FIG. 3(e), which is parallel to the rotation axis of the stirring member 13a, at least one of the first stirring blade 22 and the second stirring blade 23 may have a through hole 26. It is not limited how many through holes 26 or in what position through holes 26 are provided. The cross-sectional shape of the through hole 26 may be exactly circular, semicircular, polygonal, or linear.

The stirring member 13a according to the embodiment shown in FIGS. 3(a) to 3(g) is configured to rotate about the rotation axis C extending in the vertical direction like that according to the embodiment shown in FIGS. 1 and 2.

The stirring unit 13 has the stirring member 13a provided in the inner space of the analyte storage section 11. In the stirring unit 13 with such a configuration, the stirring member 13a preferably has a bottom portion with a rotation area that is larger than the cross-sectional area of the flow path of the outlet 11c of the analyte storage section 11 when the stirring member 13a is rotated. The stirring member 13a with such a rotation area larger than the flow path cross-sectional area of the outlet 11c can prevent the analytes in the fluid from settling out directly on the outlet 11c.

The rotation area refers to a (virtual) cross-sectional area of the stirring member 13a rotating about the rotation axis C when viewed in the rotation axis C direction. In other words, the rotation area is the area of a circular cross-section that is perpendicular to the rotation axis C of the stirring member 13a and is defined by a circumference through which an end of the stirring member 13a most distant from the rotation axis C passes when the stirring member 13a is rotated about the rotation axis C.

The stirring member 13a is also preferably spaced at a predetermined distance from the inner surface of the analyte storage section 11. The stirring member 13a with such a configuration can be stably rotated by the stirring driver 13b so that the analytes in the solution can be stably stirred.

The stirring member 13a also preferably has a rotation axis that is coincident with the center of the horizontal cross-section of the analyte storage section 11 when viewed in the rotation axis direction of the stirring member 13a. In the analyte identifying and sorting apparatus 1 with such a configuration, the fluid stored in the analyte storage section 11 can be stirred so as to flow around the center of the analyte storage section 11 in the horizontal cross-section, so that the whole of the analyte-containing solution can be efficiently stirred. In a preferred embodiment according to the present invention, the stirring member 13a may have a rotation axis that is coincident with the center of the horizontal cross-section of the analyte storage section 11 and with the center of the horizontal cross-section of the flow path 15a of the introduction nozzle 15 when viewed in the rotation axis direction of the stirring member 13a. In the analyte identifying and sorting apparatus 1 with such a configuration, the fluid stored in the analyte storage section 11 can be stirred so as to flow around the center of the outlet 11c and the center of the analyte storage section 11 in the horizontal cross-section, so that the whole of the analyte-containing solution can be efficiently stirred.

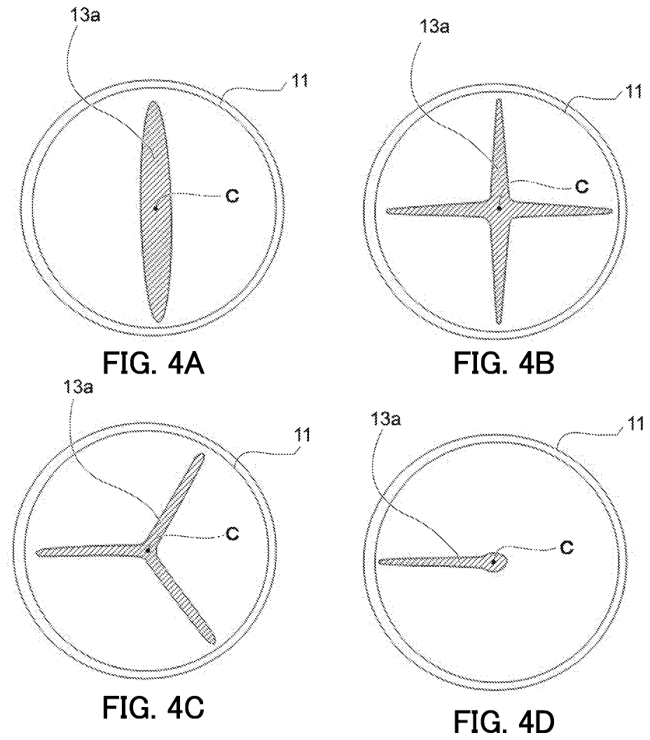

The preferred shape of the stirring member 13a may be any shape as long as the stirring member 13a has the configurations described above. For example, as shown in FIGS. 4(a) to 4(d), the stirring member 13a may have various configurations, such as various cross-sectional shapes perpendicular to the rotation axis C and any number of stirring blades. For example, FIG. 4(a) shows a mode in which the stirring member 13a has two stirring blades (right and left) spaced at an angle of about 180° about the rotation axis C as the center; FIG. 4(b) shows a mode in which the stirring member 13a has four stirring blades spaced at an angle of about 90° about the rotation axis C as the center; FIG. 4(c) shows a mode in which the stirring member 13a has three stirring blades spaced at an angle of about 120° about the rotation axis C as the center; and FIG. 4(d) shows a mode in which the stirring member 13a has a single stirring blade extending in a single radial direction from the rotation axis C as the center. Each stirring blade may have not only a thin cross-sectional shape extending substantially linearly in the radial direction about the rotation axis C as shown in FIGS. 4(a) to 4(d), but also a curved cross-sectional shape such as a cycloidal cross-sectional shape.

It should be noted that, when the stirring member 13a is rotated, the stirring member 13a is preferably as less likely as possible to give shear stress to cells dispersed as analytes in the liquid A. Thus, the stirring member 13a is preferably configured to have stirring blades evenly spaced about the rotation axis as the center, which is advantageous in that it allows the liquid A to form a uniform laminar flow, which is less likely to cause the sedimentation of analytes, although it depends on the rotational speed of the stirring member during the stirring, and the number of stirring blades is preferably, for example, one to four.

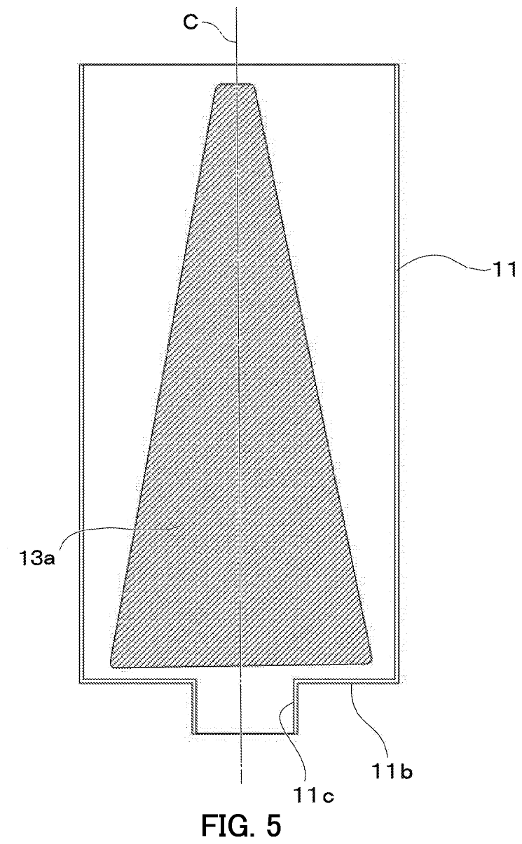

As shown in FIG. 5, the stirring blade preferably has a horizontal width increasing gradually in the direction from the top side of the analyte storage section to the bottom side of the analyte storage section 11. The stirring blade may have a shape with a width larger at its bottom side than at its upper side, such as a trapezoidal cross-sectional shape or a triangular cross-sectional shape. Such a blade shape can provide a larger stirring force on the bottom side near the outlet 11c to address sedimentation of cells and can produce a uniform flow in a single direction to avoid collision between analytes in the stirred flow.

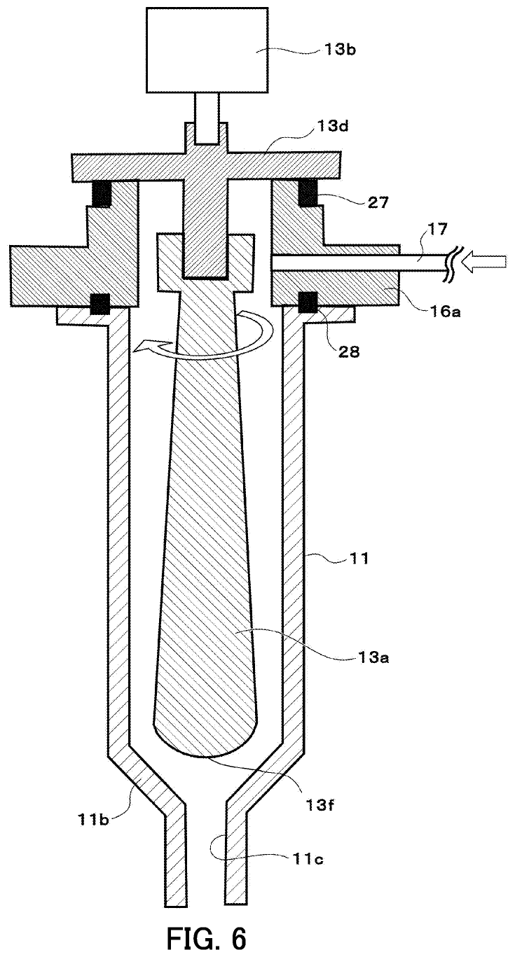

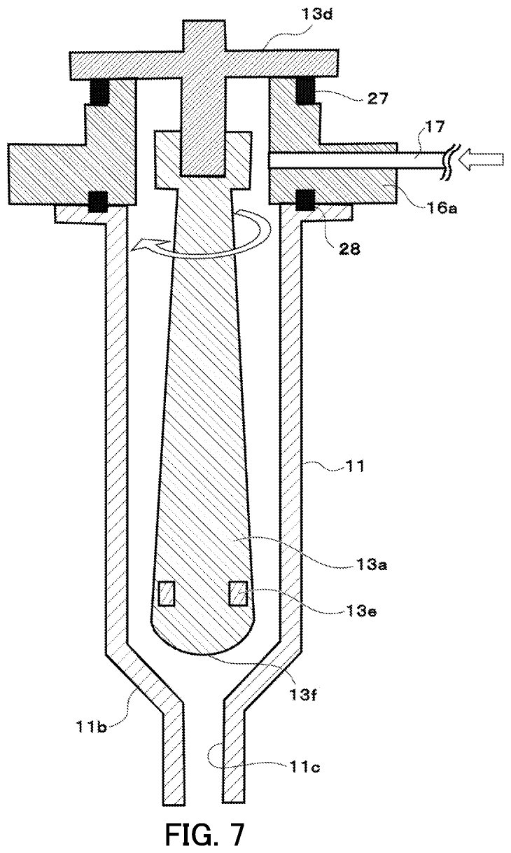

FIG. 6 is a partial vertical cross-sectional view schematically showing the configuration of the analyte storage section in the analyte identifying and sorting apparatus according to another embodiment of the present invention. FIG. 7 is a partial vertical cross-sectional view schematically showing the configuration of the analyte storage section in the analyte identifying and sorting apparatus according to another embodiment of the present invention.

As shown in FIGS. 6 and 7, the analyte storage section 11 has a bottom portion 11b inclined toward the outlet 11c, which differs from the flat bottom extending horizontally in the embodiment shown in FIG. 2 or 5. In the embodiment shown in FIGS. 6 and 7, the analyte storage section 11 is a central type with the outlet 11c provided at the center of the bottom portion 11b. The bottom portion 11b of the analyte storage section 11 has a tapered shape extending toward the outlet 11c, in other words, is gradually inclined toward the outlet 11c and extends downward. In the central type analyte storage section 11, the bottom portion 11b is narrowed toward the outlet 11c. Thus, the bottom portion 11b has a flow path cross-sectional area that is larger than that of the outlet 11c and decreases toward the outlet 11c. In the analyte identifying and sorting apparatus 1 according to the present invention, the bottom portion 11b of the analyte storage section 11 is preferably inclined and reduced in diameter toward the outlet 11c as shown in FIGS. 6 and 7. This configuration can suppress the analytes from staying on the bottom portion 11b in the process of feeding the liquid A downward from the analyte storage section 11 while stirring the liquid A with the stirring member 13a, and thus can reduce the number of analytes remaining in the analyte storage section 11.

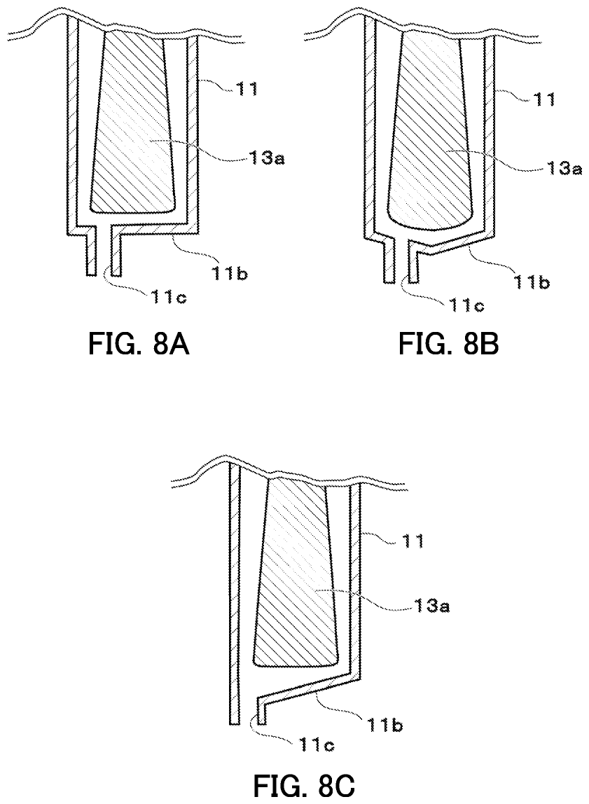

FIGS. 8(a) to 8(c) are cross-sectional views showing the configuration of the bottom portion of the analyte storage section in the analyte identifying and sorting apparatus according to a further embodiment of the present invention. In the embodiment shown in FIGS. 8(a) to 8(c), the analyte storage section may be an eccentric type with the outlet 11c provided at a portion other than the center of the bottom portion lib, besides the central type shown in FIGS. 2 and 5 to 7. In this case, the outlet 11c located eccentrically is not coincident with the rotation axis of the stirring member 13a when viewed in the rotation axis direction of the stirring member 13a. As shown in FIGS. 8(a) to 8(c), like the central type, the eccentric type analyte storage section 11 may have a flat bottom portion lib shown in FIG. 8(a), which extends horizontally and is not inclined toward the outlet 11c, or may have a tapered bottom portion lib shown in FIGS. 8(b) and 8(c) with a flow path cross-sectional area decreasing toward the outlet 11c. As shown in FIG. 8(c), the outlet 11c may also be provided at a periphery-side end portion of the inclined bottom portion lib, in other words, at a position most distant from the center of the bottom portion lib. The outlet 11c provided at a periphery-side end portion of the bottom portion lib can suppress the analytes from staying on the bottom portion lib in the process of feeding the liquid A downward from the analyte storage section 11 while stirring the liquid A with the stirring member 13a.

The inclined bottom portion lib preferably has an angle α of inclination of more than 0° and 70° or less, and more preferably 5° or more and 45° or less. The angle α of inclination of the bottom portion 11b is the angle between the bottom portion lib and the horizontal plane h. The bottom portion lib with an angle α of inclination of more than 0° can suppress the analytes from staying on the bottom portion 11b. When the bottom portion lib has an angle α of inclination of 70° or less, the stirring member 13a can be easily spaced at a predetermined distance from the inner surface of the analyte storage section 11. In this regard, the flat bottom portion lib shown in FIG. 8(a) has an angle α of inclination of 0°.

In the embodiment shown in FIGS. 6 and 7, the stirring member 13a has a bottommost end 13f that is rounded and tapered corresponding to the shape of the bottom portion 11b of the analyte storage section 11 and is spaced at a predetermined distance from the bottom portion 11b of the analyte storage section 11.

It should be noted that examples of the blade shape with a horizontal width gradually increasing in the direction from the top side to the bottom side of the analyte storage section 11 may also include the shape of the blade according to the embodiment shown in FIGS. 6 and 7, which have a portion finally tapered at or near the bottommost end 13f of the stirring blade in accordance with the shape of the bottom portion lib of the analyte storage section 11.

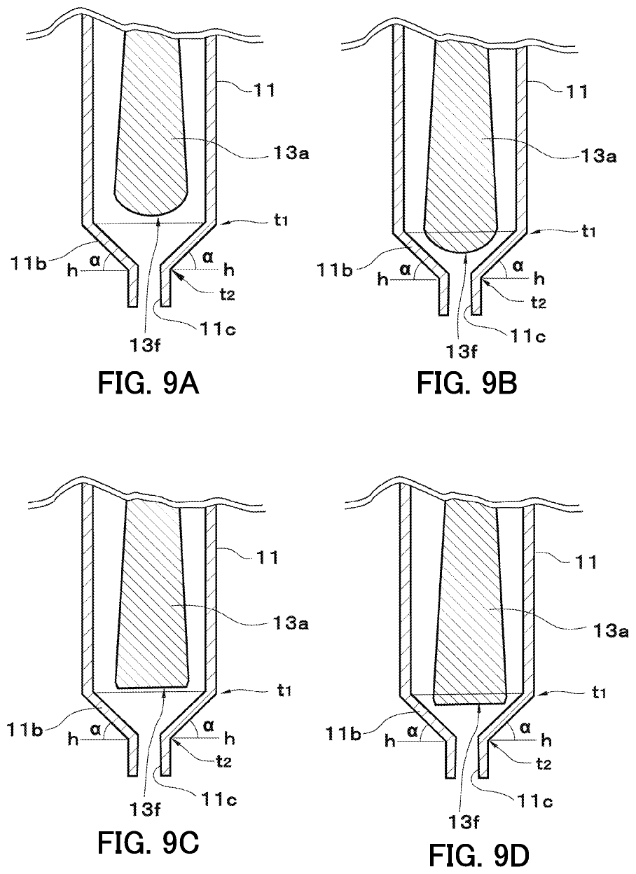

FIGS. 9(a) to 9(d) are cross-sectional views schematically showing the positional relationship between the stirring member 13a and the bottom portion lib of the analyte storage section 11. In the embodiment shown in FIGS. 9(a) to 9(d), the bottom portion lib of the analyte storage section 11 is inclined as in the embodiment shown in FIGS. 6 and 7. Regarding the vertical positional relationship between the bottom portion lib and the bottommost end 13f of the stirring member 13a in the analyte storage section 11, the bottommost end 13f may be located above the upper end t1 of the bottom portion lib as shown in FIG. 9(a) or 9(c) or may be located above the lower end t2 of the bottom portion lib and below the upper end t1 of the bottom portion lib as shown in FIG. 9(b) or 9(d). The upper end t1 of the bottom portion lib is connected to the side wall of the analyte storage section 11, and the upper end t1 of the bottom portion lib is connected to the outlet 11c. For example, the bottommost end 13f of the stirring member 13a may be rounded and tapered as shown in FIG. 9(a) or 9(b) or may have a flat shape extending along the horizontal plane as shown in FIG. 9(c) or 9(d).

Moreover, in the embodiment shown in FIGS. 6 and 7, the analyte storage section 11 and the stirring member 13, which should preferably be replaced at relatively frequent intervals since they are in direct contact with the analyte dispersion during the operation, are easily detachable from other components, such as a grip block 16a and a rotary shaft part 13d, which are durable during use and should have higher strength or stiffness, and a reliable airtight structure is provided at the joint between them. Specifically, the analyte identifying and sorting apparatus according to the embodiment shown in FIGS. 6 and 7 includes a grip block 16a that is provided on the top of the analyte storage section 11 to support from below the rotary shaft part 13d connected to the stirring member 13a and is connected through a pipe 17 to a pressure control section 65 (not shown) provided outside to control the pressure in the inner space of the analyte storage section 11. The grip block 16a has a through hole extending in the vertical direction, and the lower opening of the through hole of the grip block 16a is connected to an upper opening of the analyte storage section 11. The analyte storage section 11 has a flanged joint face at the upper end. The flanged joint face of the analyte storage section 11 is airtightly attached to the lower face of the grip block 16a with a sealing member 28 such as an O-ring so that the analyte storage section 11 is detachably attached, for example, as a disposable component. If necessary, a configuration such as a screwed fitting structure, a grooved fitting structure, adhesive or sticking agent may also be used on the joint face to increase adhesion.

In the analyte identifying and sorting apparatus according to the embodiment shown in FIGS. 6 and 7, the rotary shaft part 13d connected to the stirring member 13a has a circular joint face, which is abutted on the upper annular opening face of the grip block 16a, and also has a shaft portion connectable to the stirring member 13a at the center of the joint face. When the joint face of the rotary shaft part 13d is abutted on the upper annular opening face of the grip block 16a, the upper opening of the through hole of the grip block 16a is closed, and the rotary shaft part 13d is supported by the grip block 16a while the shaft of the rotary shaft part 13d remains rotatable. A sealing member 27 such as an O-ring or a seal bearing is provided for the abutment between the upper annular opening face of the grip block 16a and the joint face of the rotary shaft part 13d. For example, the sealing member 27 is abutted on the rotary shaft part 13d from outside the upper annular opening face of the grip block 16a, in other words, outside the upper opening of the through hole of the grip block 16a. The rotary shaft part 13d is held by the grip block 16a and a fitting member (not shown) as an accessory of the stirring driver 13b, and the sealing member 27 is pressed between the rotary shaft part 13d and the grip block 16a. The resulting structure ensures the airtightness at the joint between the rotary shaft part 13d and the grip block 16a. The sealing material 27 is provided on a circumference outside the upper opening of the analyte storage section 11. This eliminates the risk that any wear debris resulting from the friction of the sealing member 27 could drop into the analyte storage section.

In the embodiment shown in FIGS. 6 and 7, the upper end portion of the stirring member 13a is provided with a joint structure that detachably connects the stirring member 13a to the lower end of the rotary shaft part 13d by a suitable joint structure, such as a screwed, grooved, or elastic fitting structure. The stirring member 13a attached to the rotary shaft part 13d is suspended from above and supported at a predetermined position in the inner space of the analyte storage section 11. In the embodiment shown in FIG. 6, the stirring member 13a is connected to and rotated by the stirring driver 13b. In the embodiment shown in FIG. 7, magnetic parts 13e including a permanent magnet or a magnetic metal are provided in portions near the side surfaces of the stirring member 13a, specifically, in portions near the lower side surfaces, and are embedded in the stirring member 13a, in which a non-contact stirring driver 13b (not shown) non-connected to the stirring member 13a is provided to rotate the stirring member 13a. In this case, the stirring driver 13b produces a magnetic force to rotate the stirring member 13a.

In the present invention, as mentioned above, the stirring member 13a is spaced at a predetermined distance from the inner surface of the analyte storage section 11. In this regard, the spacing is preferably 0.4 to 3.0 mm although it depends on the scale of the analyte identifying and sorting apparatus 1, the rotational speed of the stirring member 13a, and other factors. When the spacing is in this range, the stirring member 13a can be smoothly rotated without colliding with the inner surface of the analyte storage section 11 even if the axis deviates slightly at the time of rotating the stirring member 13a, and the fluid can be prevented from forming a stagnant region between the stirring member 13a and the inner surface of the analyte storage section 11. As used herein, the spacing means a shortest distance between the stirring member 13a and the inner surface of the analyte storage section 11.

The bottom portion of the stirring member 13a preferably follows the shape of the bottom portion of the analyte storage section 11 while being spaced at a predetermined distance from the bottom portion of the analyte storage section 11. This configuration can stir the liquid near the bottom of the stirring member 13a to maintain suspending the analytes into the liquid and to prevent the analytes from remaining on the bottom portion of the analyte storage section 11.

The stirring member 13a has a thickness of, for example, 0.5 mm or more and 2.0 mm or less. When the thickness is in this range, the analyte-containing liquid can be thoroughly stirred with the stirring member 13. As used herein, the thickness of the stirring member 13a refers to the maximum thickness of a horizontal longitudinal portion (excluding the central axis portion) of the stirring member 13a.

The stirring member 13a may be made of any material. Preferably, the stirring member 13a is made of a material that is as inactive to the analytes dispersed in the liquid A as possible and is resistant to conditions under which sterilization treatment such as autoclaving sterilization or γ-ray sterilization is performed. For example, the stirring member 13a is preferably made of an engineering plastic material, such as polyether ketone resin, such as polyether ether ketone (PEEK), polyether ketone (PEK) or polyether ketone ether ketone ketone (PEKEKK), fluororesin, such as polytetrafluoroethylene (PTFE), tetrafluoroethylene-perfluoroalkylvinylether (PFA) copolymer, tetrafluoroethylene-hexafluoropropylene (FEP) copolymer, or tetrafluoroethylene-ethylene (ETFE) copolymer, polyphenylene sulfide, or polyimide; or a metallic material, such as stainless steel. The stirring member 13a also preferably has a mirror-finished surface, which is less likely to cause a reaction with the analytes, such as sticking to the analytes dispersed in the liquid A, or preferably has a chamfered portion, such as a rounded corner or a rounded edge, to prevent damage to the analytes.

The stirring unit including the stirring member 13a with such configuration may be driven by any means. For example, according to the embodiment shown in FIG. 2 or 6, the stirring driver 13b may include a drive motor or the like provided above the analyte storage section 11, and a drive shaft may be provided to extend from the stirring driver 13b. Alternatively, for example, according to the embodiment shown in FIG. 7, a magnet may be provided in the stirring member 13a in the inner space of the analyte storage section 11 or provided in a portion of the stirring member 13a extending to outside the analyte storage section 11, and another magnet may be provided to produce a magnetic force between the magnets to rotate the stirring member 13a.

In the present invention, the stirring is preferably performed to maintain the dispersity in the analyte storage section, which may be achieved by adjusting the shape of the stirring member or the rotational speed the stirring member. The stirring member including the stirring blade may be rotated during the period of the analyte identifying and sorting operation and, if necessary, during the warm-up period for the operation. As long as the dispersity is maintained in the analyte storage section, the stirring member may be continuously rotated or intermittently rotated at regular or irregular intervals during these periods.

A flow cell 12 is disposed below the analyte storage section 11 having the configuration describe above. An introduction nozzle 15 is disposed between the analyte storage section 11 and the flow cell 12. The introduction nozzle 15 has a linearly-shaped flow path 15a extending downward to introduce the liquid A discharged from the analyte storage section 11 into the flow path 12a of the flow cell 12. A sorting nozzle 14 is disposed below the flow cell 12. The sorting nozzle 14 has a linearly-shaped flow path 14a extending downward. The sorting nozzle 14 introduces the liquid A discharged from the flow path 12a of the flow cell 12 into wells of a culture plate 55.

The introduction nozzle 15 is a tubular member having a predetermined cross-sectional shape, and has a tapered portion 15b at the lower end side. The upper end portion of the introduction nozzle 15 is fixed to the bottom portion lib of the analyte storage section 11 such that the inlet side of the flow path 15a is connected to the outlet 11c of the analyte storage section 11. The tapered portion 15b of the introduction nozzle 15 is fixed to a tapered hole 12b by press fitting, screw fitting, or the like. The tapered hole 12b is provided in an upper end portion of the flow cell 12 to communicate with the flow path 12a. The tapered portion 15b and the tapered hole 12b may be replaced with a non-tapered linear portion and a non-tapered linear hole.

The flow cell 12 has a sheath liquid introduction hole 18 which is connected to the linearly-shaped flow path 12a and is provided to introduce an analyte-free liquid (sheath liquid) B into the flow path 12a. The flow cell 12 also has a sheath liquid introduction portion 19 which is provided to introduce the sheath liquid B at a predetermined adjusted pressure into the sheath liquid introduction hole 18.

In the flow path 12a of the flow cell 12, the sheath liquid B surrounds the liquid A so that the analytes S and SR dispersed in the liquid A can flow individually. The flow of the liquid A is called the sample flow, and the flow of the sheath liquid B, which surrounds (in other words, enclose) the sample flow, is called the sheath flow. Accordingly, in the flow path 12a, a sheath flow-forming portion is formed to surround the path of the sample flow. For example, in the flow path 12a of the flow cell 12, the sheath liquid flows downward while surrounding the entire circumference of the downward sample flow.

In the analyte identifying and sorting apparatus of the embodiment having the sheath liquid introduction portion 19 with such configuration, the pressure control section 65 controls the pressure in the analyte storage section 11 by evacuating air from the analyte storage section 11 through the pipe 17 (releasing the air with the open valve 20 such as a three-way valve) or by reducing the pressure in the analyte storage section 11 so that the sheath liquid B is allowed to flow back into the analyte storage section 11 through the outlet 11c after being introduced into the flow path 12a of the flow cell 12. Such back flow can stir the liquid in the analyte storage section 11 and in particular can stir the liquid in the vicinity of the outlet 11. Therefore, if the analytes are more likely to settle out near the outlet 11c, such back flow of the sheath liquid may be performed for stirring to eliminate such a settlement before the analyte identifying and sorting operation.

The sorting nozzle 14 is fixed to the lower end portion of the flow cell 12 such that the flow path 12a is connected to the linearly-shaped flow path 14a. The flow cell 12 and the sorting nozzle 14 may be separately provided or integrated together.

In the analyte identifying and sorting apparatus 1 according to this embodiment, the outlet 11c of the analyte storage section 11 is connected to the linearly-shaped flow path 15a of the introduction nozzle 15, the flow path 15a is connected to the linearly-shaped flow path 12a of the flow cell 12, and the flow path 12a is connected to the linearly-shaped flow path 14a of the sorting nozzle 14. Thus, a flow path from the analyte storage section 11 to the tip of the sorting nozzle 14 is provided to extend in the vertical direction. The central axis of the flow path 15a of the introduction nozzle 15 extending in the vertical direction, the central axis of the flow path 12a of the flow cell 12 extending in the vertical direction, and the central axis of the flow path 14a of the sorting nozzle 14 extending in the vertical direction each preferably make an angle in the range of ±3° with respect to the vertical direction along the direction of gravitational force and more preferably make an angle of 0°, namely, are parallel to the vertical direction. When the angle between the central axis of each of the flow paths and the vertical direction is in such a range, the stability of the stirring by the back flow of the sheath liquid B, the stability of the sheath flow-forming portion, and the accuracy of the optical information of the analyte irradiated with excitation light can be efficiently improved.

The analyte identifying and sorting apparatus 1 further includes measurement systems 30 and 40 that measure the optical information of the analytes S and SR irradiated with excitation light, which are contained in the liquid A flowing through the flow path 12a of the flow cell 12. As shown in FIGS. 1 and 2, the two measurement systems 30 and 40 are arranged at two different positions around the flow path 12a with respect to the travel direction (the direction D of the sample flow through the flow path) of the analytes S and SR contained in the liquid A flowing through the flow path 12a of the flow cell 12. The measurement systems 30 and 40 individually irradiate the excitation light to the analyte at different positions in the travel direction of the analyte and individually measure the optical information from the analyte.

The measurement system 30 includes a light irradiation part that irradiates the excitation light to the analyte flowing thorough the flow path 12a of the flow cell 12; a transmitted light receiving part that receives the excitation light transmitted through the analyte; and a side-scattered light receiving part that receives side-scattered light and fluorescent light from the analyte.

The light irradiation part of the measurement system 30 includes a semiconductor laser device 31 that emits laser light with a predetermined wavelength (e.g., visible light at 380 nm to 750 nm) as excitation light; and an irradiation optical fiber 32 that propagates the laser light and outputs the laser light in the vicinity of the flow (sample flow) of the liquid A in the flow path 12a.

The transmitted light receiving part of the measurement system 30 includes an optical fiber 33 that receives, in the vicinity of the sample flow, the light transmitted through the analyte; and a light receiving device 34 that receives the transmitted light propagated in the optical fiber 33.

The side-scattered light receiving part of the measurement system 30 includes an optical fiber 35 that receives, in the vicinity of the sample flow, side-scattered light from the analyte; three optical filters 36a, 36b, and 36c that are attached to the optical fiber 35 to separate the side-scattered light including the fluorescent light into individual wavelengths; and four light-receiving devices 37a, 37b, 37c, and 37d that receive light separated by the optical filters.

The light receiving device 37a receives the side-scattered light reflected by the optical filter 36a. The light receiving device 37b receives the fluorescent light transmitted through the optical filter 36a and reflected by the optical filter 36b. The light receiving device 37c receives the fluorescent light transmitted through the optical filter 36b and reflected by the optical filter 36c. The light receiving device 37d receives the fluorescent light transmitted through the optical filter 36c.

The measurement system 40 includes a light irradiation part that irradiates the excitation light to the analyte flowing thorough the flow path 12a of the flow cell 12; a transmitted light receiving part that receives the excitation light transmitted through the analyte; and a fluorescent light receiving part that receives fluorescent light from the analyte.

The light irradiation part of the measurement system 40 includes a semiconductor laser device 41 that emits laser light with a predetermined wavelength (e.g., visible light at 380 nm to 750 nm) as excitation light; and an irradiation optical fiber 42 that propagates the laser light and outputs the laser light in the vicinity of the sample flow. While the semiconductor laser device is used as light sources in this embodiment, any other light source may be used to emit light with a specific wavelength.

The transmitted light receiving part of the measurement system 40 includes an optical fiber 43 that receives, in the vicinity of the sample flow, the light transmitted through the analyte; and a light receiving device 44 that receives the transmitted light propagated in the optical fiber 43.

Each of the optical fibers 32, 33, 35, 42, and 43 of the measurement systems 30 and 40 is held by the optical fiber holders 38 or 39. The optical fiber holders 38 and 39 are each positioned and fixed to the flow cell 12. The positions of the optical fiber holders 38 and 39 are freely adjustable with respect to the analyte flow.

The fluorescent light receiving part of the measurement system 40 includes an optical fiber 45 that receives the fluorescent light from the analyte in the vicinity of the sample flow; and a light receiving device 46 that receives the fluorescent light propagated in the optical fiber 45.

The analyte identifying and sorting apparatus 1 is configured to determine whether the analyte is a target analyte or a non-target analyte; to move the culture plate 55 based on the result of the determination before the target analyte reaches the tip 14b of the sorting nozzle 14; and to sort the sorted solution containing the target analyte to a well W of the culture plate 55. Specifically, the analyte identifying and sorting apparatus 1 includes a stage (not shown) that supports the culture plate 55 such that the culture plate 55 is movable relative to the sorting nozzle 14; and a drive motor that drives the stage as described later.

The analyte identifying and sorting apparatus 1 also includes an effluent collection section 50 that collects a non-target analyte-containing effluent discharged from the tip 14b of the sorting nozzle 14. The effluent collection section 50 includes a main effluent collection part 51; and a suction nozzle 52 that is provided to extend from the side surface of the effluent collection section 50 to the lateral side and to suck the non-target analyte-containing effluent discharged from the tip of the sorting nozzle through a flow path 52a (see FIG. 2). The analyte identifying and sorting apparatus 1 further includes a stage (not shown) that supports the suction nozzle 52 such that the suction nozzle 52 is movable relative to the sorting nozzle 14; and a drive motor that drives the stage as described later. As used herein, the effluent and the sorted solution refer to a liquid discharged outside from the tip 14b of the sorting nozzle 14, in which the liquid may be the liquid A, the liquid B, or a mixture of the liquids A and B.

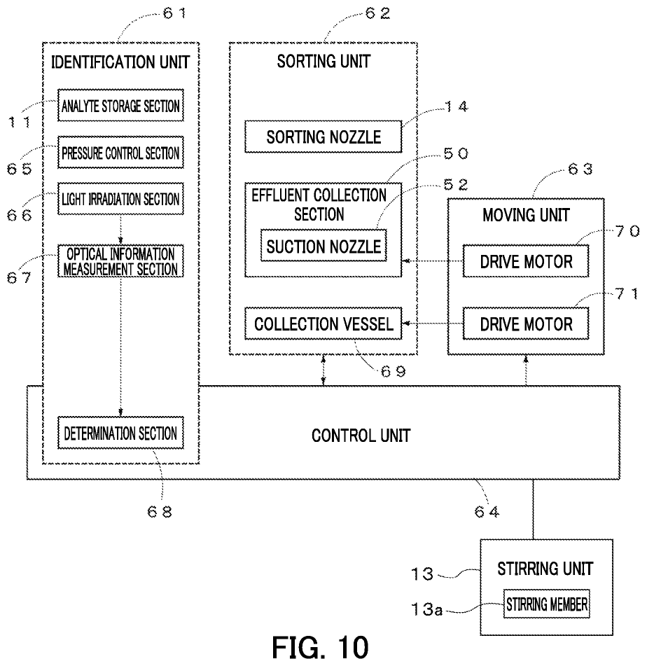

FIG. 10 is a block diagram illustrating the function of the analyte identifying and sorting apparatus shown in FIG. 1.

Referring to FIG. 10, the analyte identifying and sorting apparatus 1 includes an identification unit 61, a sorting unit 62, a moving unit 63, a control unit 64, and a stirring unit 13.

The identification unit 61 includes the analyte storage section 11 configured to store the analytes dispersed in the liquid; a pressure control section 65 configured to feed the liquid to a flow path; a light irradiation section 66 configured to irradiate light to the analytes; an optical information measurement section 67 that measures the optical information of the analytes; and a determination section 68 that determines whether each of the analytes is a target analyte or a non-target analyte based on the optical information. The optical information measurement section 67 is a functional block corresponding to the measurement systems 30 and 40 shown in FIG. 1.

The sorting unit 62 includes the sorting nozzle 14 that has a flow path connected to the flow path of the identification unit 61 and sorts a target analyte-containing sorted solution to a collection vessel as described later; an effluent collection section 50 that sucks and collects a non-target analyte-containing effluent discharged from the tip of the sorting nozzle; and a collection vessel 69 configured to collect the target analyte-containing sorted solution. In this regard, the collection vessel 69 corresponds to the culture plate 55 in the embodiment described above.

The moving unit 63 includes a drive motor 70 that drives the effluent collection section 50; and a drive motor 71 that drives the collection vessel 69, in which the drive motors 70 and 71 move the effluent collection section 50 and the collection vessel 69 by stages (not shown). Alternatively, the moving unit 63 may be configured to move the sorting nozzle 14 instead of or in combination with being configured to move the collection vessel 69 and the effluent collection section 50.

The control unit 64 determines whether the analyte is a target analyte (analyte S) or a non-target analyte (analyte SR) on the basis of the optical information (each of transmitted light information, side-scattered light information, and fluorescent light information) acquired by each light receiving part in the measurement systems 30 and 40, namely, by each of the light receiving devices 34, 44, 37a to 37d, and 46. The control unit 64 is configured to measure the flow velocity V of the analyte S or SR based on the difference between the time when the optical information is acquired by the light receiving device 34 in the measurement system 30 and the time when the optical information is acquired by the light receiving device 44 in the measurement system 40 and the distance between the light receiving devices 34 and 44; and to calculate the time T in which the analyte S or SR reaches the tip of the sorting nozzle 14 based on the measured flow velocity V. In this embodiment, the determination section 68 is provided as a part of the control unit 64. Alternatively, the control unit 64 and the determination section 68 may be separately provided.

When the control unit 64 determines that the analyte is the analyte S, the control unit 64 performs a control to drive the drive motor 71 before the calculated time T elapses. As a result, the collection vessel 69 is moved upward, and the tip 14b of the sorting nozzle 14 is inserted into a liquid in the collection vessel 69. Subsequently, the sorted solution 86 containing the analyte S is sorted from the tip 14b to the liquid in the collection vessel 69. That is, the control unit 64 calculates the flow velocity V of the analyte S on the basis of the optical information measured by the optical information measurement section 67 and calculates the time T in which the analyte S reaches the tip 14b of the sorting nozzle 14 on the basis of the flow velocity V. Subsequently, the control unit 64 moves the collection vessel 69 and/or the sorting nozzle 14 such that the tip 14b of the sorting nozzle 14 is dipped into the liquid in the collection vessel before the time T elapses.

As described above, the stirring unit 13 includes the stirring member provided in the inner space of the analyte storage section 11 that stores the analytes dispersed in the liquid. The stirring member is rotated to keep the dispersion state of the analytes S and SR dispersed in the liquid A stored in the inner space of the analyte storage section 1.

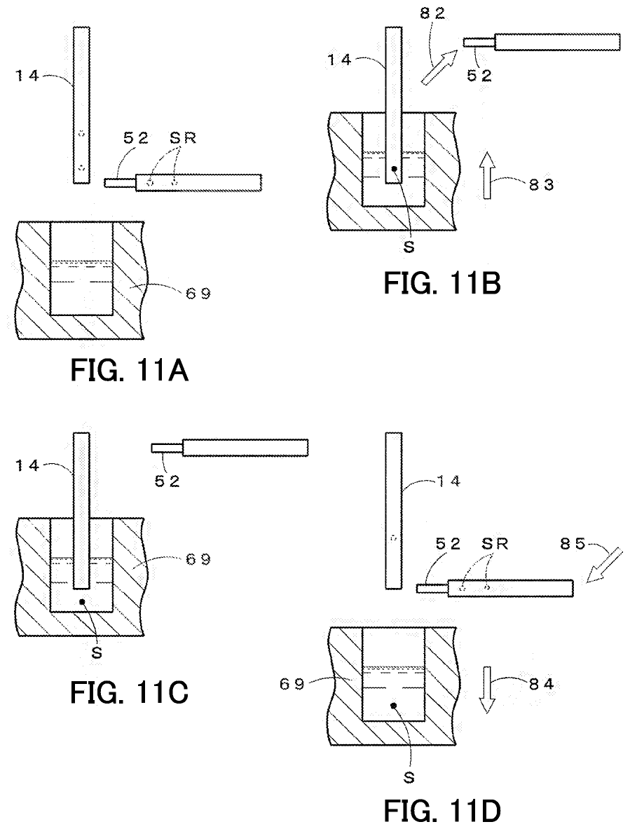

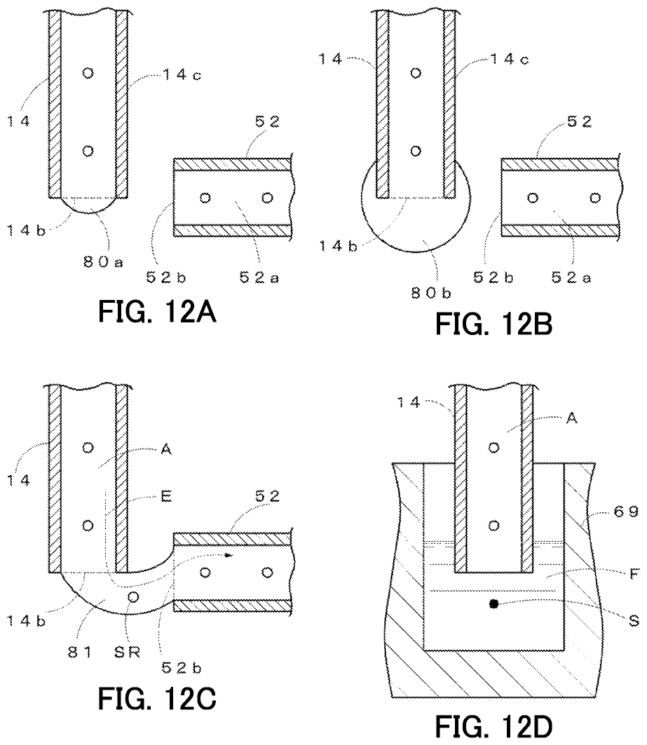

FIGS. 11(a) to 11(d) are views illustrating operation of the sorting unit 62 shown in FIG. 10, and FIGS. 12(a) to 12(d) are enlarged views of the area at and near the sorting nozzle during the operation shown in FIGS. 11(a) to 11(d).

First, in the standby state, the suction nozzle 52 stays at a position that is close to the side surface 14c of the sorting nozzle 14 and spaced apart at most about 1 mm from the side surface 14c, and sucks the effluent, the effluent containing the non-target analyte SR or the target analyte S determined to be impossible to sort discharged from the tip of the sorting nozzle (see FIG. 11(a)). At this time, the effluent forms a downward convex effluent 80a (see FIG. 12(a)) while being discharged at a predetermined pressure from the tip 14b of the sorting nozzle 14, and then the effluent is lifted upward along the side surface 14c by a surface tension of the sorting nozzle 14 to form a substantially spherical effluent 80b (see FIG. 2(b)). Subsequently, the effluent 80b undergoes the suction force from the suction nozzle 52 to turn into an effluent 81 flowing from the tip 14b to the tip 52b (indicated by the arrow E in FIG. 12(c)). For this process, an end face of the tip 52b of the suction nozzle is preferably arranged substantially parallel to the direction of the flow through the sorting nozzle 14. This configuration makes it possible to reliably suck the effluent.

When the analyte is determined to be possible to sort and determined to be the analyte S, the drive motor 70 is driven at a predetermined timing to move the suction nozzle 52 upward (indicated by the arrow 82 in FIG. 11(b)). The suction nozzle 52 is operated to perform a single motion obliquely or vertically upward. Simultaneously with the upward movement of the suction nozzle 52, the correction vessel 69 is moved upward (indicated by the arrow 83) by the drive motor 71 and then the correction vessel 69 is stopped at a position where the tip 14b of the sorting nozzle 14 is inserted into the liquid in the collection vessel 69. Thus, the sorting nozzle 14 is inserted into the collection vessel 69 before the analyte S is discharged from the sorting nozzle 14. It takes, for example, a time period of 40 ms from when the suction nozzle 52 starts to move to when the sorting nozzle 14 is inserted into the liquid in the collection vessel 69. The time T in which the analyte S is discharged from the tip of the sorting nozzle 14 is, for example, 70 ms. Subsequently, the sorted solution 86 containing the analyte S is sorted to the correction vessel 69 (see FIG. 11(c)). At this time, the analyte S-containing sorted solution 86 is mixed with the liquid F in the collection vessel 69 without coming into contact with the ambient air or the end face of the tip 14b (see FIG. 12 (d)).

After the analyte S is sorted, the collection vessel 69 is moved downward (indicated by the arrow 84) by the drive motor 71 (see FIG. 11(d)). Simultaneously with the downward movement of the collection vessel 69 or after the start of the downward movement of the collection vessel 69, the suction nozzle 52 is moved downward (indicated by the arrow 85) by the drive motor 70. The suction nozzle 52 is operated to perform a single motion obliquely or vertically downward. It takes, for example, a time period of 120 ms from when the collection vessel 69 starts to move to when the suction nozzle 52 comes to a stop. As a result of this operation, the suction nozzle 52 and the collection vessel 69 are returned to the standby position, and the suction nozzle 52 sucks again the analyte SR-containing effluent discharged from the tip 14b of the sorting nozzle 14.

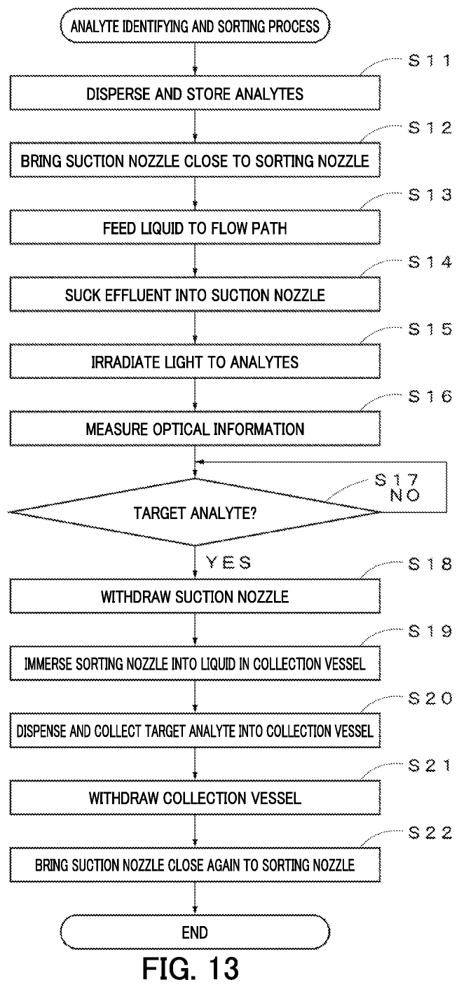

FIG. 13 is a flowchart of an analyte identifying and sorting process performed in the analyte identifying and sorting apparatus 1 shown in FIG. 1.

First, the analytes S and SR dispersed in the liquid A are stored in the analyte storage section 11 (storage step: step S11). In this state, the stirring unit 13 is operated in the analyte storage section 11 to stir the liquid A in the analyte storage section 11 so that the analytes are uniformly dispersed and suspended in the liquid A. During the steps S11 to S22, the stirring operation of the liquid A by the stirring unit 13 may be continuously performed or intermittently performed at regular or irregular intervals as described above. Before the stirring unit 13 is operated to stir the liquid A, for example, an additional step (not shown) may be performed, which includes reducing the pressure in the analyte storage section 11 to allow the sheath liquid B to flow back from the outlet 11c into the analyte storage section 11 after the sheath liquid B is introduced into the flow path 12a of the flow cell 12; and allowing such back flow to stir the liquid in the analyte storage section 11. The stirring by the sheath liquid B back flow may be performed not only before the stirring of the liquid A by the stirring unit 13 but also during any of the steps S11 to S22. Next, the tip 52b of the suction nozzle 52 is brought close to the tip 14b of the sorting nozzle 14 and then stopped at the standby position (step S12). Subsequently, while the liquid A is stirred by the stirring unit 13 as mentioned above, a predetermined pressure is applied to the analyte storage section 11 through the pipe 17 to feed the liquid A to the flow path 14a (liquid feeding step: step S13). When the fluid flowing through the flow path 14a is an effluent discharged from the tip of the sorting nozzle, the suction nozzle 52 sucks and collects the effluent at the standby position (collection step: step S14). As mentioned above, the suction nozzle 52 staying at the standby position close to the sorting nozzle 14 successfully sucks and collects the effluent discharged from the tip 14b of the sorting nozzle 14.

Next, the excitation light is irradiated to the analytes S and SR flowing through the flow path 14a (irradiation step: step S15), and the optical information received by each light receiving device is measured (measurement step: step S16). On the basis of the optical information, it is determined whether each of the analytes flowing through the flow path 14a is a target analyte S or a non-target analyte SR (determination step: step S17).

When the fluid flowing through the flow path 14a is determined not to contain the target analyte S (NO) and determined to be an effluent to be discharged from the tip of the sorting nozzle or to be an effluent containing the non-target analyte SR or the target analyte S determined to be impossible to sort, the standby position in the step S12 is maintained, and the suction nozzle sucks and collects the effluent discharged from the tip of the sorting nozzle or the effluent containing the non-target analyte SR or the target analyte S determined to be impossible to sort (step S14). Subsequently, the determination step S17 is repeatedly performed on the subsequent flow.

When each analyte flowing through the flow path 14a is determined to be the target analyte S (YES), the suction nozzle 52 is withdrawn from the standby position so that the tip 52b of the suction nozzle 52 is taken away from the tip 14b of the sorting nozzle 14 (step S18). Upon the withdrawing of the suction nozzle 52, the collection vessel 69 (and/or the sorting nozzle 14) is moved relatively so that the tip 14b of the sorting nozzle 14 is inserted into the collection vessel 69 and is immersed into the liquid in the vessel 69 (control step: step S19). The target analyte S-containing sorted solution is discharged from the tip of the sorting nozzle and sorted into the collection vessel 69 so that the analyte S is collected by the collection vessel 69 (sorting step: step S20). Subsequently, the collection vessel 69 is moved back to the standby position (step S21), the suction nozzle 52 is moved again to the standby position, the tip 52b of the suction nozzle 52 is brought close to the tip 14b of the sorting nozzle 14 (step S22), and then the process is completed.

As described above, according to this embodiment, the flow velocity V of the target analyte is calculated based on the optical information of the analyte S, and the time T in which the analyte S reaches the tip of the sorting nozzle is calculated based on the flow velocity V. Before the time T elapses, the collection vessel 69 is moved such that the tip of the sorting nozzle is immersed in the liquid in the collection vessel 69. Subsequently, the analyte S-containing sorted solution 86 is discharged from the tip 14b of the sorting nozzle 14 and sorted to the collection vessel 69. In this process, the analyte S is collected into the liquid in the collection vessel 69 without coming into contact with the ambient air or the end face or outer wall of the sorting nozzle 14, and is prevented from being damaged or contaminated by contact with the sorting nozzle 14 or the ambient air. The analyte SR-containing effluent discharged from the tip 14b of the sorting nozzle 14 is sucked and collected. Due to this operation, the distance and duration of the mechanical upward and downward movement of the effluent collection section can be made significantly shorter than that in the conventional art, which allows a rapid sorting process.

As described above, the analyte identifying and sorting apparatus according to the present invention can stably and rapidly identify and sort the analytes while being less likely to cause sedimentation or clogging even when relatively large analytes are contained in the liquid stored in the analyte storage section. Therefore, the analytes to be sorted may be any type, which may include not only normal cells with a diameter of about 1 μm to about 30 μm but also large cells with a diameter of about 40 to about 100 μm, such as megakaryocytes, primordial germ cells (PGCs), murine oocytes, and bowel cancer cells; atypical cells with a long diameter of about 40 to about 100 μm, such as cardiomyocytes; spheroids with a diameter of about 50 to about 300 μm, such as stem cells and clumps of retinal pigment epithelial cells; and spheroids with a diameter of about 50 to about 300 μm, such as gastric epithelium cells, large intestine epithelial cells, pancreatic duct epithelium cells, intrahepatic bile duct epithelial cells, intestinal epithelial cells, and liver cells.

While the invention made by the inventors has been specifically described with reference to some embodiments, it will be understood that such embodiments are not intended to limit the present invention and may be altered or modified without departing from the gist of the present invention.

### EXPLANATION OF REFERENCE NUMERALS

1: Analyte identifying and sorting apparatus
11: Analyte storage section
13: Stirring unit
13a: Stirring member
14: Sorting nozzle
50: Effluent collection section
61: Identification unit
62: Sorting unit
64: Control unit
65: Pressure control section
66: Light irradiation section
67: Optical information measurement section
68: Determination section
69: Collection vessel

1. An analyte identifying and sorting apparatus for identifying analytes dispersed as measurement targets in a liquid and for sorting a target analyte based on a result of identification, the apparatus comprising:
an identification unit comprising an analyte storage section, a pressure control section, a light irradiation section, an optical information measurement section, and a determination section, the analyte storage section being configured to store analytes dispersed in a liquid, the pressure control section being configured to feed the liquid from an outlet to a flow path, the outlet being provided at a bottom portion of the analyte storage section, the flow path being provided to extend downward from the outlet, the light irradiation section being configured to irradiate light to the analytes, the optical information measurement section measuring optical information of the analytes, and the determination section determining whether each of the analytes is a target analyte or a non-target analyte based on the optical information;
a sorting unit comprising a sorting nozzle, an effluent collection section, and a collection vessel, the sorting nozzle having a flow path connected to the flow path of the identification unit and sorting a sorted solution containing the target analyte to the vessel, the effluent collection section having a suction nozzle to suck and collect an effluent discharged from a tip of the sorting nozzle or an effluent containing a non-target analyte or an analyte determined to be impossible to sort, and the collection vessel being configured to collect the sorted solution containing the target analyte;
a moving unit that moves at least one of the sorting nozzle and the collection vessel;
a control unit that moves the sorting nozzle and/or the collection vessel relatively based on the optical information measured by the optical information measurement section; and
a stirring unit comprising a stirring member provided in an inner space of the analyte storage section.

2. The analyte identifying and sorting apparatus according to claim 1, wherein the stirring member is rotated about a rotation axis extending in a vertical direction.

3. The analyte identifying and sorting apparatus according to claim 1, wherein the stirring member has a bottom portion with a rotation area that is larger than an area of the outlet of the analyte storage section when the stirring member is rotated.

4. The analyte identifying and sorting apparatus according to claim 1, wherein the analyte storage section has a bottom portion inclined toward the outlet.

5. The analyte identifying and sorting apparatus according to claim 1, wherein the stirring member is spaced apart from an inner surface of the analyte storage section.

6. The analyte identifying and sorting apparatus according to claim 1, wherein the stirring member has at least one stirring blade extending in a horizontal direction from the vertically extending rotation axis of the stirring member.

7. The analyte identifying and sorting apparatus according to claim 6, wherein the stirring blade has a horizontal width increasing gradually in a direction from a top side of the analyte storage section to a bottom side of the analyte storage section.

8. The analyte identifying and sorting apparatus according to claim 1, further comprising a flow path that is connected to the flow path of the identification unit and allows an analyte-free liquid to form a sheath flow-forming portion surrounding an analyte-containing liquid output from the analyte storage section, and the analyte identifying and sorting apparatus being configured to allow the analyte-free liquid to flow back from the outlet of the analyte storage section to effect stirring in the analyte storage section.

9. An analyte identifying and sorting method for identifying analytes dispersed as measurement targets in a liquid and for sorting a target analyte based on a result of identification, the method comprising:
storing analytes in an analyte storage section, the analytes being dispersed in a liquid, the analyte storage section having an outlet for the liquid at a bottom portion;
feeding the liquid to a flow path, the liquid being stirred by a stirring unit including a stirring member provided in an inner space of the analyte storage section;
irradiating light to the analytes;
measuring optical information of the analytes;
determining whether each of the analytes is a target analyte or a non-target analyte based on the optical information;
sucking and collecting an effluent discharged from a tip of a sorting nozzle connected to the flow path or an effluent containing a non-target analyte or an analyte determined to be impossible to sort by a suction nozzle;
making a control based on the optical information to move the sorting nozzle and/or a collection vessel relatively such that the tip of the sorting nozzle is inserted into the collection vessel; and
sorting a sorted solution containing the target analyte discharged from the tip of the sorting nozzle to the collection vessel.

10. The analyte identifying and sorting apparatus according to claim 2, wherein the stirring member has a bottom portion with a rotation area that is larger than an area of the outlet of the analyte storage section when the stirring member is rotated.

11. The analyte identifying and sorting apparatus according to claim 2, wherein the analyte storage section has a bottom portion inclined toward the outlet.

12. The analyte identifying and sorting apparatus according to claim 2, wherein the stirring member is spaced apart from an inner surface of the analyte storage section.

13. The analyte identifying and sorting apparatus according to claim 2, wherein the stirring member has at least one stirring blade extending in a horizontal direction from the vertically extending rotation axis of the stirring member.

14. The analyte identifying and sorting apparatus according to claim 2, further comprising a flow path that is connected to the flow path of the identification unit and allows an analyte-free liquid to form a sheath flow-forming portion surrounding an analyte-containing liquid output from the analyte storage section, and the analyte identifying and sorting apparatus being configured to allow the analyte-free liquid to flow back from the outlet of the analyte storage section to effect stirring in the analyte storage section.

15. The analyte identifying and sorting apparatus according to claim 3, wherein the analyte storage section has a bottom portion inclined toward the outlet.

16. The analyte identifying and sorting apparatus according to claim 3, wherein the stirring member is spaced apart from an inner surface of the analyte storage section.

17. The analyte identifying and sorting apparatus according to claim 3, wherein the stirring member has at least one stirring blade extending in a horizontal direction from the vertically extending rotation axis of the stirring member.

18. The analyte identifying and sorting apparatus according to claim 3, further comprising a flow path that is connected to the flow path of the identification unit and allows an analyte-free liquid to form a sheath flow-forming portion surrounding an analyte-containing liquid output from the analyte storage section, and the analyte identifying and sorting apparatus being configured to allow the analyte-free liquid to flow back from the outlet of the analyte storage section to effect stirring in the analyte storage section.

19. The analyte identifying and sorting apparatus according to claim 4, wherein the stirring member is spaced apart from an inner surface of the analyte storage section.

20. The analyte identifying and sorting apparatus according to claim 4, wherein the stirring member has at least one stirring blade extending in a horizontal direction from the vertically extending rotation axis of the stirring member.
